(19) United States
(12) Patent Application Publication
(10) Pub. No.: US 2026/0360814 A1
(43) Pub. Date: Nov. 12, 2026

(54) CARBON DIOXIDE SATURATED ELECTROLYTES FOR ENERGY STORAGE DEVICE, AND METHODS THEREOF

(71) Applicant: Tesla, Inc., Austin, TX (US)

(72) Inventors: Tyler Evans, Broomfield, CO (US); Ashley Heist, Broomfield, CO (US); Daniela Molina Piper, Broomfield, CO (US)

(21) Appl. No.: 19/104,804

(22) PCT Filed: Sep. 28, 2023
(86) PCT No.: PCT/US2023/033981

§ 371 Date: Feb. 19, 2025

Related U.S. Application Data
(60) Provisional application No. 63/377,638, filed on Sep. 29, 2022.

(51) Int. Cl. H01M 10/0567; H01M 4/02; H01M 4/38; H01M 4/62; H01M 10/0568; H01M 10/0569; H01M 50/609

(52) U.S. Cl. CPC H01M 10/0567; H01M 4/386; H01M 4/625; H01M 10/0568; H01M 10/0569; H01M 50/609; H01M 2004/021; H01M 2004/027; H01M 2220/20; H01M 2300/0034; H01M 2300/0051

(57) ABSTRACT

Provided herein are electrolyte additives and formulations for energy storage devices having improved performance. The electrolyte includes at least one carbon dioxide source dissolved in a fluorinated solvent. The improved performance may be realized as improved cycling stability.

### INCORPORATION BY REFERENCE TO ANY PRIORITY APPLICATIONS

Any and all applications for which a foreign or domestic priority claim is identified in the Application Data Sheet or PCT Request as filed with the present application are hereby incorporated by reference under 37 CFR 1.57, and Rules 4.18 and 20.6. The present application claims priority to U.S. Provisional Patent Application No. 63/377,638, filed Sep. 29, 2022, the disclosure of which is incorporated herein by reference in its entirety and for all purposes.

### BACKGROUND

### Field

The present disclosure relates generally to energy storage devices, and specifically to improved electrolyte formulations for use in energy storage devices.

### Description of the Related Art

Energy storage devices are widely used to provide power to electronic, electromechanical, electrochemical, and other useful devices. Such cells include primary chemical cells, secondary (rechargeable) cells, fuel cells, and various species of capacitors, including ultracapacitors. Increasing the operating voltage and temperature of energy storage devices, including batteries and capacitors, would be desirable for enhancing energy storage, increasing power capability, and broadening real-world use cases.

Lithium ion batteries have been relied on as a power source in numerous commercial and industrial uses, for example, in consumer devices, productivity devices, and in battery powered vehicles. However, demands placed on energy storage devices are continuously—and rapidly—growing. For example, the automotive industry is developing vehicles that rely on compact and efficient energy storage, such as plug-in hybrid vehicles and pure electric vehicles. Lithium ion batteries are well suited to meet future demands however improvements in energy density are needed to provide longer life batteries that can travel further on a single charge. The electrolyte is one component in conventional lithium ion batteries that determines electrochemical performance as well as safety of those batteries, where the compatibility between electrode and electrolyte in part governs battery cell performance.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

One embodiment is a lithium-ion battery. The battery may include: a cathode; an anode; and an electrolyte comprising lithium ions and at least one carbon dioxide source dissolved in a fluorinated solvent.

In one aspect, an energy storage device is described. The energy storage device comprises: a cathode; an anode; and an electrolyte comprising a lithium salt, a carbon dioxide source and a fluorinated solvent. In some embodiments, a concentration of the carbon dioxide source in the electrolyte is in a range from 0.1 to 10% by weight.

In some embodiments, the carbon dioxide source is selected from the group consisting of gaseous carbon dioxide, dry ice, diethyl pyrocarbonate (DEPC), dimethyl pyrocarbonate (DMPC), diallyl pyrocarbonate (DAPC), bis(tert-butyl) pyrocarbonate (O-Boc2), and combinations thereof. In further embodiments, the carbon dioxide source is diethyl pyrocarbonate. In some embodiments, the concentration of the diethyl pyrocarbonate in the electrolyte is in a range from 1 to 6% by weight. In further embodiments, the concentration of the diethyl pyrocarbonate in the electrolyte is in a range from 1.5 to 2.5% by weight.

In some embodiments, a concentration of the fluorinated solvent in the electrolyte is in a range from 5 to 80% by weight. In some embodiments, the concentration of the fluorinated solvent in the electrolyte is in a range from 5 to 20% by weight. In some embodiments, the fluorinated solvent is selected from the group consisting of fluoroethylene carbonate (FEC), difluoroethylene carbonate (diFEC), methyl 2,2,2-trifluoroethyl carbonate (FEMC), bis(2,2,2-trifluoroethyl) carbonate (TFEC), trifluoropropylene carbonate (TFPC), 2,2,3,3-tetrafluoro-1,4-dimethoxybutane (fDMB), bis(2,2,2-trifluoroethyl) ether (BTFE), 1,1,2,2-tetrafluoroethyl-2,2,3,3-tetrafluoropropylether (TTE), and combinations thereof. In certain embodiments, the fluorinated solvent is fluoroethylene carbonate. In some embodiments, the electrolyte is substantially free of ethylene carbonate and dimethylcarbonate.

In some embodiments, the anode comprises silicon particles. In some embodiments, the d₅₀ of the silicon particles is 1-5 microns. In further embodiments, the d₅₀ of the silicon particles is 2-3 microns. In some embodiments, the anode comprises a graphite insertion material and a silicon alloying/dealloying material. In some embodiments, the cathode comprises an active material selected from the group consisting of lithium nickel manganese cobalt oxide (NMC), lithium manganese oxide (LMO), lithium nickel dioxide (LNO), lithium iron phosphate (LFP), and lithium nickel cobalt aluminium oxide (NCA). In some embodiments, the lithium salt is selected from the group consisting of lithium hexafluorophosphate, lithium bis(fluorosulfonyl)imide, and combinations thereof.

In some embodiments, the energy storage device is configured to have at least 70% retention of initial capacity after 100 cycles between 4.1 V and 2.85 V at a charging rate of C3: C2. In further embodiments, the energy storage device is configured to have at least 70% retention of initial capacity after 140 cycles between 4.1 V and 2.85 V at a charging rate of C3: C2. In some embodiments, the energy storage device is a battery. In some embodiments, the energy storage device is configured to have at least 70% retention of initial capacity after 225 cycles between 4.2 V and 2.85 V at a charging rate of C4: C3.

In another aspect, an electric vehicle with a rechargeable battery is described. In some embodiments, the electric vehicle with a rechargeable battery comprises: a drive motor; gear box; electronics; and the energy storage device described herein.

In another aspect, a method of preparing an electrolyte is described. The method comprises: combining a carbon dioxide source, a fluorinated solvent and a lithium salt to form an electrolyte. In some embodiments, the method further comprises aging the electrolyte. In some embodiments, the method further comprises filling the electrolyte into an energy storage device. In some embodiments, the electrolyte is positioned within an energy storage device.

### BRIEF DESCRIPTION OF THE DRAWINGS

FIG. 1 is an X-ray photoelectron spectroscopy (XPS) characterization of solid electrolyte interphase (SEI) constituents resulting from the cycling of electrolyte formulations according to some embodiments.

FIG. 2 includes data plots of cycling data with electrolyte systems according to some embodiments relative to baseline electrolyte systems.

FIG. 3A is an X-ray photoelectron spectroscopy (XPS) depth profiling of the atomic concentration (%) vs. sputtering depth for solid electrolyte interphase (SEI) constituents resulting from the cycling of electrolyte formulations according to some embodiments.

FIG. 3B is an X-ray photoelectron spectroscopy (XPS) characterization of solid electrolyte interphase (SEI) constituents resulting from the cycling of electrolyte formulations according to some embodiments.

FIG. 4 includes data plots of capacity retention during cycling with electrolyte systems according to some embodiments relative to baseline electrolyte systems.

FIG. 5 is a bar graph showing the gas formation of electrolyte systems according to some embodiments relative to baseline electrolyte systems.

FIG. 6 is a plot showing discharge capacity versus the cycle number of cells with electrolyte systems injected with gaseous carbon dioxide according to some embodiments relative to a baseline electrolyte system.

FIG. 7A is a plot showing discharge capacity versus the cycle number of cells with electrolyte systems comprising varying amounts of solvent blends according to some embodiments.

FIG. 7B is a plot showing the gas formation of electrolyte systems comprising varying amounts of solvent blends according to some embodiments.

FIG. 8A is a plot showing discharge capacity versus cycle number of cells with electrolyte systems comprising diethyl pyrocarbonate (DEPC) according to some embodiments relative to a baseline electrolyte system.

FIG. 8B is a plot showing discharge capacity versus cycle number of cells with electrolyte systems comprising diethyl pyrocarbonate (DEPC) according to some embodiments relative to a baseline electrolyte system.

FIG. 8C is a plot showing the gas formation of electrolyte systems comprising diethyl pyrocarbonate (DEPC) according to some embodiments.

### DETAILED DESCRIPTION

The present disclosure may be understood by reference to the following detailed description. It is noted that, for purposes of illustrative clarity, certain elements in various drawings may not be drawn to scale, may be represented schematically or conceptually, or otherwise may not correspond exactly to certain physical configurations of embodiments.

Electrolyte formulations comprising at least one additive, or the salt thereof, for high-voltage, high-energy density energy storage devices (e.g., lithium ion batteries) are described. In some embodiments, such additives may react with lithium salts to improve device performances, such as stabilizing electrode surfaces. Such device improvements may beneficially afford improved cycling stability. The present disclosure further relates to electrolyte formulations which improve cell cycling through stabilizing the solid electrolyte interphase (SEI).

Embodiments relate to the application of an electrolyte formulation uniquely tailored for high energy anodes, fully optimized for CO₂ saturation and balanced fluorinated solvent content in a cell design that does not include too much CO₂ gas. In some embodiments, the CO₂ and fluorinated solvent may be applied into an electrolyte formulation and the CO₂+fluorinated solvent may increase the lifespan of energy storage devices, such as lithium ion batteries. In some embodiments, the lithium ion battery comprises a micron-silicon anode. In some embodiments, the lithium ion battery comprises a graphite anode. Furthermore, additives, such as DEPC, may be included in the electrolyte formulation and provide advantageous results, as discussed below. In some embodiments, the electrolyte does not contain any ethylene carbonate (EC) or dimethyl carbonate (DMC). In some embodiments the anode is made from an insertion material (such as carbon or graphite) and an alloying/dealloying material (such as silicon, silicon oxide, tin, and/or tin oxide).

### DEFINITIONS

Unless defined otherwise, all technical and scientific terms used herein have the same meaning as is commonly understood by one of ordinary skill in the art. All patents, applications, published applications and other publications referenced herein are incorporated by reference in their entirety unless stated otherwise. In the event that there are a plurality of definitions for a term herein, those in this section prevail unless stated otherwise.

Whenever a group is described as being “optionally substituted” that group may be unsubstituted or substituted with one or more of the indicated substituents. Likewise, when a group is described as being “unsubstituted or substituted” if substituted, the substituent(s) may be selected from one or more of the indicated substituents. If no substituents are indicated, it is meant that the indicated “optionally substituted” or “substituted” group may be substituted with one or more group(s) individually and independently selected from deuterium (D), halogen, hydroxy, C₁₋₄ alkoxy, C₁₋₈ alkyl, C₃₋₂₀ cycloalkyl, aryl, heteroaryl, heterocyclyl, C₁₋₆ haloalkyl, cyano, C₂₋₈ alkenyl, C₂₋₈ alkynyl, C₃₋₂₀ cycloalkenyl, aryl(alkyl), heteroaryl(alkyl), heterocyclyl(alkyl), acyl, thiocarbonyl, C-carboxy, O-carboxy, sulfenyl, sulfinyl, sulfonyl, haloalkoxy, an amino, a mono-substituted amine group and a di-substituted amine group.

As used herein, “Cₐ to C_{b}” in which “a” and “b” are integers refer to the number of carbon atoms in a group. The indicated group can contain from “a” to “b”, inclusive, carbon atoms. Thus, for example, a “C₁ to C₄ alkyl” group refers to all alkyl groups having from 1 to 4 carbons, that is, CH₃—, CH₃CH₂—, CH₃CH₂CH₂—, (CH₃)₂CH—, CH₃CH₂CH₂CH₂—, CH₃CH₂CH(CH₃)— and (CH₃)₃C—. If no “a” and “b” are designated, the broadest range described in these definitions is to be assumed.

If two “R” groups are described as being “taken together” the R groups and the atoms they are attached to can form a cycloalkyl, cycloalkenyl, aryl, heteroaryl or heterocycle. For example, without limitation, if R^{a} and R^{b} of an NR^{a}R^{b} group are indicated to be “taken together,” it means that they are covalently bonded, either indirectly through intermediate atoms, or directly to one another, to form a ring, for example:

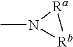

As used herein, the term “alkyl” refers to a fully saturated aliphatic hydrocarbon group. The alkyl moiety may be branched or straight chain. Examples of branched alkyl groups include, but are not limited to, isopropyl, sec-butyl, t-butyl and the like. Examples of straight chain alkyl groups include, but are not limited to, methyl, ethyl, propyl, butyl, pentyl, hexyl, heptyl, and the like.

The term “alkenyl” used herein refers to a monovalent straight or branched chain radical of from two to thirty carbon atoms containing a carbon double bond(s) including, but not limited to, 1-propenyl, 2-propenyl, 2-methyl-1-propenyl, 1-butenyl, 2-butenyl and the like. An alkenyl group may be unsubstituted or substituted.

The term “alkynyl” used herein refers to a monovalent straight or branched chain radical of from two to thirty carbon atoms containing a carbon triple bond(s) including, but not limited to, 1-propynyl, 1-butynyl, 2-butynyl and the like. An alkynyl group may be unsubstituted or substituted.

As used herein, “cycloalkyl” refers to a completely saturated (no double or triple bonds) mono- or multi-cyclic hydrocarbon ring system. When composed of two or more rings, the rings may be joined together in a fused, bridged or spiro fashion. As used herein, the term “fused” refers to two rings which have two atoms and one bond in common. For example, in the following structure, rings A and B are fused

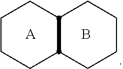

As used herein, the term “bridged cycloalkyl” refers to compounds wherein the cycloalkyl contains a linkage of one or more atoms connecting non-adjacent atoms. The following structures

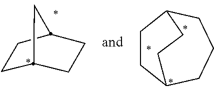 [SMILES: C1CC2CCC1C2 ; C1CC2CCC(C1)CC2]

are examples of “bridged” rings. As used herein, the term “spiro” refers to two rings which have one atom in common and the two rings are not linked by a bridge. Cycloalkyl groups can contain 3 to 30 atoms in the ring(s), 3 to 20 atoms in the ring(s), 3 to 10 atoms in the ring(s), 3 to 8 atoms in the ring(s) or 3 to 6 atoms in the ring(s). A cycloalkyl group may be unsubstituted or substituted. Examples of mono-cycloalkyl groups include, but are in no way limited to, cyclopropyl, cyclobutyl, cyclopentyl, cyclohexyl, cycloheptyl and cyclooctyl. Examples of fused cycloalkyl groups are decahydronaphthalenyl, dodecahydro-1H-phenalenyl and tetradecahydroanthracenyl; examples of bridged cycloalkyl groups are bicyclo[1.1.1]pentyl, adamantanyl, and norbornanyl; and examples of spiro cycloalkyl groups include spiro[3.3]heptane and spiro[4.5]decane.

As used herein, “cycloalkenyl” refers to a mono- or multi-cyclic hydrocarbon ring system that contains one or more double bonds in at least one ring; although, if there is more than one, the double bonds cannot form a fully delocalized pi-electron system throughout all the rings (otherwise the group would be “aryl,” as defined herein). Cycloalkenyl groups can contain 3 to 30 atoms in the ring(s), 3 to 20 atoms in the ring(s), 3 to 10 atoms in the ring(s), 3 to 8 atoms in the ring(s) or 3 to 6 atoms in the ring(s). When composed of two or more rings, the rings may be connected together in a fused, bridged or spiro fashion. A cycloalkenyl group may be unsubstituted or substituted.

As used herein, “cycloalkynyl” refers to a mono- or multi-cyclic hydrocarbon ring system that contains one or more triple bonds in at least one ring. If there is more than one triple bond, the triple bonds cannot form a fully delocalized pi-electron system throughout all the rings. Cycloalkynyl groups can contain 8 to 30 atoms in the ring(s), 8 to 20 atoms in the ring(s) or 8 to 10 atoms in the ring(s). When composed of two or more rings, the rings may be joined together in a fused, bridged or spiro fashion. A cycloalkynyl group may be unsubstituted or substituted.

As used herein, “aryl” refers to a carbocyclic (all carbon) monocyclic or multicyclic aromatic ring system (including fused ring systems where two carbocyclic rings share a chemical bond) that has a fully delocalized pi-electron system throughout all the rings. The number of carbon atoms in an aryl group can vary. For example, the aryl group can be a C₆-C₁₄ aryl group, a C₆-C₁₀ aryl group, or a C₆ aryl group. Examples of aryl groups include, but are not limited to, benzene, naphthalene and azulene. An aryl group may be substituted or unsubstituted.

As used herein, “heteroaryl” refers to a monocyclic or multicyclic aromatic ring system (a ring system with fully delocalized pi-electron system) that contain(s) one or more heteroatoms (for example, 1, 2 or 3 heteroatoms), that is, an element other than carbon, including but not limited to, nitrogen, oxygen and sulfur. The number of atoms in the ring(s) of a heteroaryl group can vary. For example, the heteroaryl group can contain 4 to 14 atoms in the ring(s), 5 to 10 atoms in the ring(s) or 5 to 6 atoms in the ring(s). Furthermore, the term “heteroaryl” includes fused ring systems where two rings, such as at least one aryl ring and at least one heteroaryl ring, or at least two heteroaryl rings, share at least one chemical bond. Examples of heteroaryl rings include, but are not limited to, furan, furazan, thiophene, benzothiophene, phthalazine, pyrrole, oxazole, benzoxazole, 1,2,3-oxadiazole, 1,2,4-oxadiazole, thiazole, 1,2,3-thiadiazole, 1,2,4-thiadiazole, benzothiazole, imidazole, benzimidazole, indole, indazole, pyrazole, benzopyrazole, isoxazole, benzoisoxazole, isothiazole, triazole, benzotriazole, thiadiazole, tetrazole, pyridine, pyridazine, pyrimidine, pyrazine, purine, pteridine, quinoline, isoquinoline, quinazoline, quinoxaline, cinnoline and triazine. A heteroaryl group may be substituted or unsubstituted.

As used herein, “heterocyclyl” or “heteroalicyclyl” refers to three-, four-, five-, six-, seven-, eight-, nine-, ten-, up to 18-membered monocyclic, bicyclic and tricyclic ring system wherein carbon atoms together with from 1 to 5 heteroatoms constitute said ring system. A heterocycle may optionally contain one or more unsaturated bonds situated in such a way, however, that a fully delocalized pi-electron system does not occur throughout all the rings. The heteroatom(s) is an element other than carbon including, but not limited to, oxygen, sulfur and nitrogen. A heterocycle may further contain one or more carbonyl or thiocarbonyl functionalities, so as to make the definition include oxo-systems and thio-systems such as lactams, lactones, cyclic imides, cyclic thioimides and cyclic carbamates. When composed of two or more rings, the rings may be joined together in a fused or spiro fashion. Additionally, any nitrogens in a heteroalicyclic may be quaternized. Heterocyclyl or heteroalicyclic groups may be unsubstituted or substituted. Examples of such “heterocyclyl” or “heteroalicyclyl” groups include but are not limited to, 1,3-dioxin, 1,3-dioxane, 1,4-dioxane, 1,2-dioxolane, 1,3-dioxolane, 1,4-dioxolane, 1,3-oxathiane, 1,4-oxathiin, 1,3-oxathiolane, 1,3-dithiole, 1,3-dithiolane, 1,4-oxathiane, tetrahydro-1,4-thiazine, 2H-1,2-oxazine, maleimide, succinimide, barbituric acid, thiobarbituric acid, dioxopiperazine, hydantoin, dihydrouracil, trioxane, hexahydro-1,3,5-triazine, imidazoline, imidazolidine, isoxazoline, isoxazolidine, oxazoline, oxazolidine, oxazolidinone, thiazoline, thiazolidine, morpholine, oxirane, piperidine N-Oxide, piperidine, piperazine, pyrrolidine, pyrrolidone, pyrrolidione, 4-piperidone, pyrazoline, pyrazolidine, 2-oxopyrrolidine, tetrahydropyran, 4H-pyran, tetrahydrothiopyran, thiamorpholine, thiamorpholine sulfoxide, thiamorpholine sulfone and their benzo-fused analogs (e.g., benzimidazolidinone, tetrahydroquinoline and/or 3,4-methylenedioxyphenyl).

As used herein, “aralkyl” and “aryl(alkyl)” refer to an aryl group connected, as a substituent, via a lower alkylene group. The lower alkylene and aryl group of an aralkyl may be substituted or unsubstituted. Examples include but are not limited to benzyl, 2-phenylalkyl, 3-phenylalkyl and naphthylalkyl.

As used herein, “heteroaralkyl” and “heteroaryl(alkyl)” refer to a heteroaryl group connected, as a substituent, via a lower alkylene group. The lower alkylene and heteroaryl group of heteroaralkyl may be substituted or unsubstituted. Examples include but are not limited to 2-thienylalkyl, 3-thienylalkyl, furylalkyl, thienylalkyl, pyrrolylalkyl, pyridylalkyl, isoxazolylalkyl and imidazolylalkyl and their benzo-fused analogs.

A “heteroalicyclyl(alkyl)” and “heterocyclyl(alkyl)” refer to a heterocyclic or a heteroalicyclylic group connected, as a substituent, via a lower alkylene group. The lower alkylene and heterocyclyl of a (heteroalicyclyl)alkyl may be substituted or unsubstituted. Examples include but are not limited tetrahydro-2H-pyran-4-yl(methyl), piperidin-4-yl(ethyl), piperidin-4-yl(propyl), tetrahydro-2H-thiopyran-4-yl(methyl) and 1,3-thiazinan-4-yl(methyl).

“Alkylene groups” and “lower alkylene groups” are straight-chained —CH₂— tethering groups, forming bonds to connect molecular fragments via their terminal carbon atoms. Examples include but are not limited to methylene (—CH₂—), ethylene (—CH₂CH₂—), propylene (—CH₂CH₂CH₂—), and butylene (—CH₂CH₂CH₂CH₂—). An alkylene group can be substituted by replacing one or more hydrogen of the alkylene group with a substituent(s) listed under the definition of “substituted” and/or by substituting both hydrogens on the same carbon with a cycloalkyl group

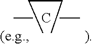

As used herein, the term “hydroxy” refers to a —OH group.

As used herein, “alkoxy” refers to the formula —OR wherein R is an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl) is defined herein. A non-limiting list of alkoxys is methoxy, ethoxy, n-propoxy, 1-methylethoxy (isopropoxy), n-butoxy, iso-butoxy, sec-butoxy, tert-butoxy, phenoxy and benzoxy. An alkoxy may be substituted or unsubstituted.

As used herein, “acyl” refers to a hydrogen, alkyl, alkenyl, alkynyl, aryl, heteroaryl, heterocyclyl, aryl(alkyl), heteroaryl(alkyl) and heterocyclyl(alkyl) connected, as substituents, via a carbonyl group. Examples include formyl, acetyl, propanoyl, benzoyl and acryl. An acyl may be substituted or unsubstituted.

A “cyano” group refers to a “—CN” group.

The term “halogen atom” or “halogen” as used herein, means any one of the radio-stable atoms of column 7 of the Periodic Table of the Elements, such as, fluorine, chlorine, bromine and iodine.

A “thiocarbonyl” group refers to a “—C(═S) R” group in which R can be the same as defined with respect to O-carboxy. A thiocarbonyl may be substituted or unsubstituted.

An “O-carbamyl” group refers to a “—OC(═O)N(R_{A}R_{B})” group in which R_{A} and R_{B} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). An O-carbamyl may be substituted or unsubstituted.

An “N-carbamyl” group refers to an “ROC(═O)N(R_{A})—” group in which R and R_{A} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). An N-carbamyl may be substituted or unsubstituted.

An “O-thiocarbamyl” group refers to a “—OC(═S)—N(R_{A}R_{B})” group in which R_{A} and R_{B} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). An O-thiocarbamyl may be substituted or unsubstituted.

An “N-thiocarbamyl” group refers to an “ROC(═S)N(R_{A})—” group in which R and R_{A} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). An N-thiocarbamyl may be substituted or unsubstituted.

A “C-amido” group refers to a “—C(—O)N(R_{A}R_{B})” group in which R_{A} and R_{B} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). A C-amido may be substituted or unsubstituted.

An “N-amido” group refers to a “RC(—O)N(R_{A})—” group in which R and R_{A} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). An N-amido may be substituted or unsubstituted.

A “C-thioamido” group refers to a “—C(═S)N(R_{A}R_{B})” group in which R_{A} and R_{B} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). A C-thioamido may be substituted or unsubstituted.

An “N-thioamido” group refers to a “RC(═S)N(R_{A})—” group in which R and R_{A} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). An N-thioamido may be substituted or unsubstituted.

An “S-sulfonamido” group refers to a “—SO₂N(R_{A}R_{B})” group in which R_{A} and R_{B} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). An S-sulfonamido may be substituted or unsubstituted.

An “N-sulfonamido” group refers to a “RSO₂N(R_{A})—” group in which R and R_{A} can be independently hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). An N-sulfonamido may be substituted or unsubstituted.

An “O-carboxy” group refers to a “RC(═O)O—” group in which R can be hydrogen, an alkyl, an alkenyl, an alkynyl, an alkoxy, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein. An O-carboxy may be substituted or unsubstituted.

The terms “ester” and “C-carboxy” refer to a “—C(═O) OR” group in which R can be the same as defined with respect to O-carboxy. An ester and C-carboxy may be substituted or unsubstituted.

A “sulfenyl” group refers to an “—SR” group in which R can be hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl). A sulfenyl may be substituted or unsubstituted.

A “sulfinyl” group refers to an “—S(—O)—R” group in which R can be the same as defined with respect to sulfenyl. A sulfinyl may be substituted or unsubstituted.

A “sulfonyl” group refers to an “SO₂R” group in which R can be the same as defined with respect to sulfenyl. A sulfonyl may be substituted or unsubstituted.

As used herein, “haloalkyl” refers to an alkyl group in which one or more of the hydrogen atoms are replaced by a halogen (e.g., mono-haloalkyl, di-haloalkyl and tri-haloalkyl). Such groups include but are not limited to, chloromethyl, fluoromethyl, difluoromethyl, trifluoromethyl, 1-chloro-2-fluoromethyl and 2-fluoroisobutyl. A haloalkyl may be substituted or unsubstituted.

As used herein, “haloalkoxy” refers to an alkoxy group in which one or more of the hydrogen atoms are replaced by a halogen (e.g., mono-haloalkoxy, di-haloalkoxy and tri-haloalkoxy). Such groups include but are not limited to, chloromethoxy, fluoromethoxy, difluoromethoxy, trifluoromethoxy, 1-chloro-2-fluoromethoxy and 2-fluoroisobutoxy. A haloalkoxy may be substituted or unsubstituted.

The term “nitro” as used herein refers to a —NO₂ group.

The term “amino” as used herein refers to a —NH₂ group.

A “mono-substituted amine” group refers to a “—NHR” group in which R can be an alkyl, an alkenyl, an alkynyl, a haloalkyl, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein. A mono-substituted amino may be substituted or unsubstituted. Examples of mono-substituted amino groups include, but are not limited to, —NH(methyl), —NH (phenyl) and the like.

A “di-substituted amine” group refers to a “—NR_{A}R_{B}” group in which R_{A} and R_{B} can be independently an alkyl, an alkenyl, an alkynyl, a haloalkyl, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein. A di-substituted amino may be substituted or unsubstituted. Examples of di-substituted amino groups include, but are not limited to, —N(methyl)₂, —N(phenyl)(methyl), —N(ethyl)(methyl) and the like.

Where the numbers of substituents is not specified (e.g. haloalkyl), there may be one or more substituents present. For example, “haloalkyl” may include one or more of the same or different halogens. As another example, “C₁-C₃ alkoxyphenyl” may include one or more of the same or different alkoxy groups containing one, two or three atoms.

As used herein, a radical indicates species with a single, unpaired electron such that the species containing the radical can be covalently bonded to another species. Hence, in this context, a radical is not necessarily a free radical. Rather, a radical indicates a specific portion of a larger molecule. The term “radical” can be used interchangeably with the term “group.”

It is understood that, in any compound described herein having one or more chiral centers, if an absolute stereochemistry is not expressly indicated, then each center may independently be of R-configuration or S-configuration or a mixture thereof. Thus, the compounds provided herein may be enantiomerically pure, enantiomerically enriched, racemic mixture, diastereomerically pure, diastereomerically enriched, or a stereoisomeric mixture. In addition, it is understood that in any compound described herein having one or more double bond(s) generating geometrical isomers that can be defined as E or Z, each double bond may independently be E or Z, or a mixture thereof.

In some embodiments, in any compound described, all tautomeric forms are also intended to be included. For example, without limitation, a reference to the compound

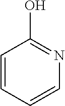

may be interpreted to include tautomer

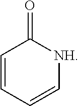

It is to be understood that where compounds disclosed herein have unfilled valencies, then the valencies are to be filled with hydrogens or isotopes thereof, e.g., hydrogen-1 (protium) and hydrogen-2 (deuterium).

### Electrolytes

The electrolyte formulations described herein can include an alkali metal salt (e.g., a lithium salt and/or a sodium salt) and one or more of the solvents discussed herein. Generally, the alkali metal salt comprises a cation and an anion. In some embodiments, the anion is redox stable. In some embodiments, the anion can be monovalent. In some embodiments, the cation on the alkali metal salt is selected from Li, Na, K and/or Rb. In some embodiments, a sodium salt can be selected from NaPF₆, NaBF₄, NaClO₄, NaN(FSO₂)₂ (NaFSI), NaB(C₂O₄)₂, and combinations thereof. In some embodiments, a lithium salt can be selected from lithium hexafluorophosphate (LiPF₆), lithium tetrafluoroborate (LiBF₄), lithium difluoro (oxalato) borate (LiDFOB), lithium bis(fluorosulfonyl)imide (LiFSI), lithium bis(trifluoromethanesulfonyl)imide (LiTFSI), lithium hexafluoroarsenate (V) (LiAsF₆), lithium perchlorate (LiClO₄), and combinations thereof. In some embodiments, the lithium salt is LiFSI. In some embodiments, the lithium salt can include an anion selected from hexafluorophosphate, tetrafluoroborate, difluoro (oxalato) borate, bis(fluorosulfonyl)imide, bis(trifluoromethanesulfonyl)imide, hexafluoroarsenate (V), and perchlorate. In certain embodiments, the salt concentration of the electrolyte can be, be about, be at most, or be at most about, 0.1 M, 0.2 M, 0.3 M, 0.4 M, 0.5 M, 0.6 M, 0.7 M, 0.8 M. 0.9 M, 1 M, 1.1 M, 1.2 M, 1.3 M, 1.4 M, 1.5 M, 1.6 M, 1.7 M, 1.8 M, 1.9 M, 2 M, 2.1 M, 2.2 M, 2.3 M, 2.4 M, 2.5 M, 2.6 M, 2.7 M, 2.8 M, 2.9 M, 3 M, 3.1 M, 3.2 M, 3.3 M, 3.4 M, 3.5 M, 3.6 M, 3.7 M, 3.8 M, 3.9 M, 4 M, 4.1 M, 4.2 M, 4.3 M, 4.4 M, 4.5 M, 4.6 M, 4.7 M, 4.8 M, 4.9 M, 5 M, 5.1 M, 5.2 M, 5.3 M, 5.4 M, 5.5 M, 5.6 M, 5.7 M, 5.8 M, 5.9 M, 6 M, 6.1 M, 6.2 M, 6.3 M, 6.4 M, 6.5 M, 6.6 M, 6.7 M, 6.8 M, 6.9 M, or 7 M, or any range of values therebetween. For example, in some embodiments, the salt concentration can be about 0.1 M to about 5 M, about 0.2 M to about 3 M, about 0.3 M to about 2 M, or about 0.7 M to about 1.5 M.

In some embodiments, the electrolyte further comprises one or more additives. In some embodiments, the additives can be selected from, for example, vinylene carbonate (VC), ethylene sulfate (DTD), lithium difluorophosphate (LFO), fluoroethylene carbonate (FEC), propene sulfone (PES), phenyl trifluoromethyl sulphide (PTS), lithium bis(oxalato) borate (LiBOB), lithium difluoro (oxalate) borate (LiDFOB), triethyl borate (TEB), trimethyl borate (TMB), tris trimethylsilyl borate (TTMSiB), 4-trifluoromethyl benzonitrile (TFMB), tris trimethyl silyl phosphite (TTSPi), tris trimethyl silyl phosphate (TTSPi), triethyl phosphite (TEPi), lithium ethoxide (EthOLi), lithium methoxide (MeOLi), lithium tetrafluoro oxalate phosphate (LiTFOP), lithium difluoro dioxalate phosphate (LiDFDOP), and combinations thereof.

In some embodiments, the electrolyte further comprises one or more additional additives. In some embodiments, the additives can be selected from, for example, diethyl pyrocarbonate (DEPC), dimethyl pyrocarbonate (DMPC), diallyl pyrocarbonate (DAPC), lithium difluoro (oxalato) borate LiDFOB, lithium difluorobis(oxalate)phosphate LiDFBOP, di-tert-butyl dicarbonate (Boc anhydride), and combinations thereof.

In some embodiments, the electrolyte comprises each additive in, in about, in at most, or in at most about, 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 7 wt. % or 8 wt. %, or any range of values therebetween. In some embodiments, the electrolyte comprises a plurality of additives that total to, to about, to at most, or to at most about, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, 7 wt. %, 7.5 wt. %, 8 wt. %, 8.5 wt. %, 9 wt. %, 9.5 wt. %, 10 wt. %, 11 wt. % or 12 wt. %, or any range of values therebetween.

### Solvents

In some embodiments, the electrolyte includes a liquid solvent. A solvent as provided herein need not dissolve every component, and need not completely dissolve each component of the electrolyte. In further embodiments, the solvent can include an organic solvent. In some embodiments, a solvent can include one or more functional groups selected from carbonates, dimer carbonates, ethers and/or esters. In some embodiments, the electrolyte includes one solvent. In other embodiments, the electrolyte includes a plurality of solvents. In some embodiments, the solvent can comprise an alkyl decarbonate compound and/or a dimerization compound (e.g., an alkyl didecarbonate compound).

In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), and combinations thereof, or acyclic carbonates such as, for example, dimethyl carbonate (DMC), diethyl carbonate (DEC), ethyl methyl carbonate (EMC), and combinations thereof. In some embodiments, the solvent can comprise fluoroethylene carbonate (FEC). In some embodiments, the solvent can further comprise methyl acetate (MA). In some embodiments, the solvent can comprise ethyl acetate (EA). In some embodiments, the solvent can comprise propionitrile (PN). In some embodiments, the solvent can comprise acetonitrile (AN). In some embodiments, the solvent can comprise butyrolactone (GBL). In some embodiments, the solvent is free or substantially free of ethylene carbonate (EC). In some embodiments, the solvent is free or substantially free of dimethyl carbonate (DMC).

In some embodiments, the solvent includes or is a fluorinated solvent. In some embodiments, a fluorinated solvent is selected from fluoroethylene carbonate (FEC), difluoroethylene carbonate (diFEC), methyl 2,2,2-trifluoroethyl carbonate (FEMC), bis(2,2,2-trifluoroethyl) carbonate (TFEC), trifluoropropylene carbonate (TFPC), 2,2,3,3-tetrafluoro-1,4-dimethoxybutane (fDMB), bis(2,2,2-trifluoroethyl) ether (BTFE), 1,1,2,2-tetrafluoroethyl-2,2,3,3-tetrafluoropropylether (TTE), and combinations thereof.

In some embodiments, the electrolyte comprises the total solvent in, in about, in at least, or in at least about, 70 wt. %, 71 wt. %, 72 wt. %, 73 wt. %, 74 wt. %, 75 wt. %, 76 wt. %, 77 wt. %, 78 wt. %, 79 wt. %, 80 wt. %, 81 wt. %, 82 wt. %, 83 wt. %, 84 wt. %, 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. % or 98 wt. %, or any range of values therebetween. In some embodiments, the electrolyte comprises each solvent individually in, in about, in at least, or in at least about, 1 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, 21 wt. %, 22 wt. %, 23 wt. %, 24 wt. %, 25 wt. %, 26 wt. %, 27 wt. %, 28 wt. %, 29 wt. %, 30 wt. %, 31 wt. %, 32 wt. %, 33 wt. %, 34 wt. %, 35 wt. %, 36 wt. %, 37 wt. %, 38 wt. %, 39 wt. %, 40 wt. %, 41 wt. %, 42 wt. %, 43 wt. %, 44 wt. %, 45 wt. %, 46 wt. %, 47 wt. %, 48 wt. %, 49 wt. %, 50 wt. %, 51 wt. %, 52 wt. %, 53 wt. %, 54 wt. %, 55 wt. %, 56 wt. %, 57 wt. %, 58 wt. %, 59 wt. %, 60 wt. %, 61 wt. %, 62 wt. %, 63 wt. %, 64 wt. %, 65 wt. %, 66 wt. %, 67 wt. %, 68 wt. %, 69 wt. %, 70 wt. %, 71 wt. %, 72 wt. %, 73 wt. %, 74 wt. %, 75 wt. %, 76 wt. %, 77 wt. %, 78 wt. %, 79 wt. %, 80 wt. %, 81 wt. %, 82 wt. %, 83 wt. %, 84 wt. %, 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. % or 98 wt. %, or any range of values therebetween.

In some embodiments, the electrolyte comprises one or more solvents. In some embodiments, the electrolyte comprises a 1, 2, 3, 4, 5 or 6 solvent system, or any range of values therebetween. In some embodiments, the electrolyte comprises a first solvent and a second solvent. In some embodiments, the electrolyte solvent system may comprise a first solvent and a second solvent in a volume ratio of about 10:1, 9:1, 8:1, 7:1, 6:1, 5:1, 4:1, 3:1, 2:1, 1:1, 1:2, 1:3, 1:4, 1:4, 1:6, 1:7, 1:8, 1:9, 1:10, or any range therebetween. For example, in some embodiments, the volume ratio can be about 3:7, about 1:1, about 1:4, about 4:1, about 3:2, or about 2:3.

### Carbon Dioxide (CO₂) Source

In some embodiments, the electrolyte includes at least one carbon dioxide source. A carbon dioxide source as provided herein can be selected from for example, gaseous carbon dioxide, dry ice (i.e., solid carbon dioxide), and pyrocarbonates, such as diethyl pyrocarbonate (DEPC) and/or a compound of Formula (A) described herein, and combinations thereof. For example, some embodiments, the carbon dioxide source comprises diethyl pyrocarbonate (DEPC).

### Formula (A)

In some embodiments, the carbon dioxide source includes or is a compound of Formula (A):

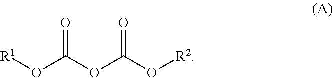

In some embodiments, R¹ and R² are independently selected from hydrogen, an optionally substituted alkyl, an optionally substituted haloalkyl, an optionally substituted alkenyl, and an optionally substituted alkynyl. In some embodiments, R¹ and R² are independently selected from an optionally substituted alkyl and an optionally substituted alkenyl.

In some embodiments, the carbon dioxide source of Formula (A) is selected from any one of or any combination of the compounds shown in Table A.

TABLE A

| Name | Structure |
|---|---|
| Dimethyl pyrocarbonate (DMPC) | 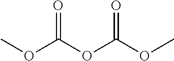 |
| Diethyl pyrocarbonate (DEPC) | 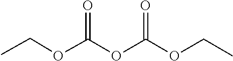 |
| Diallyl pyrocarbonate (DAPC) | 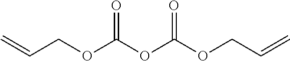 |
| Bis(tert-butyl) pyrocarbonate (O—Boc2) | 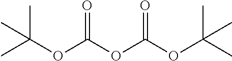 |

In some embodiments, the electrolyte comprises at least one carbon dioxide source in, in about, in at least, or in at least about, 0.01 wt. %, 0.05 wt. %, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, 20 wt. %, or any range of values therebetween.

In some embodiments, the electrolyte formulation will be fully saturated with carbon dioxide. In further embodiments, additional carbon dioxide can be included in the cell.

### Energy Storage Device

Energy storage devices of the present disclosure include the electrolyte discussed herein, a cathode, an anode, and a housing, wherein the electrolyte, cathode and anode are disposed within the housing. In some embodiments, an energy storage device as provided herein is a lithium-ion battery and/or a sodium-ion battery. In some embodiments, an energy storage device as provided herein is configured to have at least 70% retention of initial capacity after 100 cycles between 4.1 V and 2.85 V at a charging rate of C3: C2. In some embodiments, the energy storage device is configured to have at least 70% retention of initial capacity after 140 cycles between 4.1 V and 2.85 V at a charging rate of C3: C2. In some embodiments, the energy storage device is a battery. In some embodiments, the energy storage device is configured to have at least 70% retention of initial capacity after 225 cycles between 4.2 V and 2.85 V at a charging rate of C4: C3. Each of the cathode and anode include an electrode film and a current collector that form the electrode.

In some embodiments, an electrode film as provided herein includes at least one active material. In some embodiments, the electrode film further comprises at least one binder.

In some embodiments, an electrode film includes an anode active material. In some embodiments, anode active materials can include, for example, an insertion material (such as carbon or graphite), an alloying/dealloying material (such as silicon, silicon oxide, tin, and/or tin oxide), a metal alloy or compound (such as Si—Al, and/or Si—Sn), a lithium titanate (LTO), and/or a conversion material (such as manganese oxide, molybdenum oxide, nickel oxide, and/or copper oxide). The anode active materials can be used alone or mixed together to form multi-phase materials (such as Si—C, Sn—C, SiOx—C, SnOx—C, Si—Sn, Si—SiOx, Sn—SnOx, Si—SiOx—C, Sn—SnOx—C, Si—Sn—C, SiOx—SnOx—C, Si—SiOx—Sn, or Sn—SiOx—SnOx.). Anode active materials include common natural graphite, synthetic or artificial graphite, surface modified graphite, spherical-shaped graphite, flake-shaped graphite and blends or combinations of these types of graphite, hard carbon, metallic elements and its compound as well as metal-C composite for anode.

In some embodiments, anode active materials can include, for example, silicon particles. In some embodiments, the d₅₀ of the silicon particles is about 1 μm to about 10 μm. In some embodiments, the d₅₀ of the silicon particles is about 1 μm to about 5 μm. In some embodiments, the d₅₀ of the silicon particles is about, at least, or at least about 1 μm, 1.1 μm, 1.2 μm, 1.3 μm, 1.4 μm, 1.5 μm, 1.6 μm, 1.7 μm, 1.8 μm, 1.9 μm, 2 μm, 2.1 μm, 2.2 μm, 2.3 μm, 2.4 μm, 2.5 μm, 2.6 μm, 2.7 μm, 2.8 μm, 2.9 μm, 3 μm, 3.1 μm, 3.2 μm, 3.3 μm, 3.4 μm, 3.5 μm, 3.6 μm, 3.7 μm, 3.8 μm, 3.9 μm, 4 μm, 5 μm, 6 μm, 7 μm, 8 μm, 9 μm, 10 μm, or any range of values therebetween.

In some embodiments, an electrode film includes active cathode material. In some embodiments, cathode active materials can comprise, for example, a metal oxide, metal sulfide, or an alkali metal oxide (e.g., a lithium metal oxide and/or a sodium metal oxide). The lithium metal oxide can be, for example, a lithium nickel manganese cobalt oxide (NMC), a lithium manganese oxide (LMO), a lithium nickel dioxide (LNO), a lithium iron phosphate (LFP), a lithium cobalt oxide (LCO), and/or a lithium nickel cobalt aluminum oxide (NCA). In some embodiments, cathode active materials can comprise, for example, a layered transition metal oxide (such as LiCoO₂ (LCO), Li(NiMnCo)O₂ (NMC) and/or LiNi_{0.8}Co_{0.15}Al_{0.05}O₂ (NCA)), a spinel manganese oxide (such as LiMn₂O₄ and/or LiMn_{1.5}Ni_{0.5}O₄ (LMNO)), an olivine (such as LiFePO₄ (LFP), LiMn₁₋ₓFeₓPO₄ (LMFP)). The cathode active material can comprise sulfur or a material including sulfur, such as lithium sulfide (Li₂S), or other sulfur-based materials, or a mixture thereof. In some embodiments, sodium metal oxide can be, for example, a layered oxide, a phosphate, and/or a Ferri cyanide (e.g., a compound of the Prussian white family). In some embodiments, sodium metal oxide can be, for example, NaFe_{0.5}Mn_{0.5}O₂, NaNi_{1/3}Fe_{1/3}Mn_{1/3}O₂, NaFe₂(CN)₆, Na₂VOPO₄F, NaMnO₂, and/or NaFe_{0.3}Mn_{0.5}Cu_{0.2}O₂.

An energy storage device as provided herein can be of any suitable configuration, for example planar, spirally wound, button shaped, or pouch. An energy storage device as provided herein can be a component of a system, for example, a power generation system, an uninterruptible power source systems (UPS), a photo voltaic power generation system, an energy recovery system for use in, for example, industrial machinery and/or transportation. An energy storage device as provided herein may be used to power various electronic device and/or motor vehicles, including hybrid electric vehicles (HEV), plug-in hybrid electric vehicles (PHEV), and/or electric vehicles (EV).

An energy storage device including an electrolyte formulation described herein may be characterized by improved capacity retention over the life of the device. Further improvements that may be realized in various embodiments include improved cycling performance, including improved storage stability during cycling and reduced capacity fade. In some embodiments, improved cycling performance were also achieved under aggressive or stressed conditions (e.g., long constant voltage hold at 4.4V)

It will be understood that an electrolyte formulation provided herein, can be used in various embodiments with any of a number of energy storage devices and systems, such as one or more batteries, capacitors, capacitor-battery hybrids, fuel cells, or other energy storage systems or devices and combinations thereof. In some embodiments, an electrolyte additive or electrolyte including an additive described herein may be implemented in lithium ion batteries and/or sodium ion batteries.

In some embodiments, the lithium ion battery is configured to operate at about 2.5 to 4.5 V, or 3.0 to 4.2 V. In further embodiments, the lithium ion battery is configured to have a minimum operating voltage of about 2.5 V to about 3 V, respectively. In still further embodiments, the lithium ion battery is configured to have a maximum operating voltage of about 4.1 V to about 4.4 V, respectively.

### Methods of Preparing

Additives, electrolytes and energy storage devices discussed herein may be synthesized or manufactured. In some embodiments, a method for preparing an energy storage device includes preparing the electrolyte discussed herein and positioning the electrolyte within a housing comprising a cathode and an anode. In some embodiments, a method for preparing an electrolyte includes combining at least one carbon dioxide source, the fluorinated solvent and the lithium salt to form the electrolyte. In some embodiments, the electrolyte may be pre-saturating with carbon dioxide before electrolyte fill of cells during manufacturing.

In some embodiments, carbon dioxide may be introduced directly into cells by placing dry ice into the cell after the e-fill process, before sealing the cell. In some embodiments, carbon dioxide can be introduced directly into cells by injecting gaseous carbon dioxide via a feed-through port on the cell. In some embodiments, carbon dioxide may be produced in situ in the electrolyte via the use of carbon dioxide producing electrolyte additives. In some embodiments, the carbon dioxide producing electrolyte additive is mixed directly into the electrolyte prior to or subsequent to filling the electrolyte into the cell, wherein carbon dioxide is produced via chemical and/or electrochemical reactions inside the cell (e.g., during cycling).

### Aging

Some embodiments of the present disclosure relate to aging the electrolyte prior to positioning the electrolyte within the housing. In some embodiments, the electrolyte is aged for, for about, for at least, or for at least about 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, 24 hours, 25 hours, 26 hours, 27 hours, 28 hours, 29 hours, 30 hours, 31 hours, 32 hours, 33 hours, 34 hours, 35 hours, 36 hours, 37 hours, 38 hours, 39 hours, 40 hours, 41 hours, 42 hours, 43 hours, 44 hours, 45 hours, 46 hours, 47 hours, 48 hours, 3 days, 4 days, 5 days, 6 days, 7 days, 2 weeks, 3 weeks, 4 weeks, 2 months, 3 months, 4 months, or any range of values therebetween. For example, in some embodiments the electrolyte is aged for about 2 hours to about 48 hours, about 7 days to about 2 weeks, or 4 weeks to about 3 months.

In some embodiments, the electrolyte formulation of the present disclosure can be stored at room temperature. In further embodiments, the electrolyte formulation of the present disclosure maintains cell performance without being stored at low temperatures.

### EXAMPLES

Example embodiments of the present disclosure, including processes, materials and/or resultant products, are described in the following examples.

### Example 1—XPS Characterization of SEI Constituents Resulting from the Cycling of Cells with Micron-Silicon Anodes

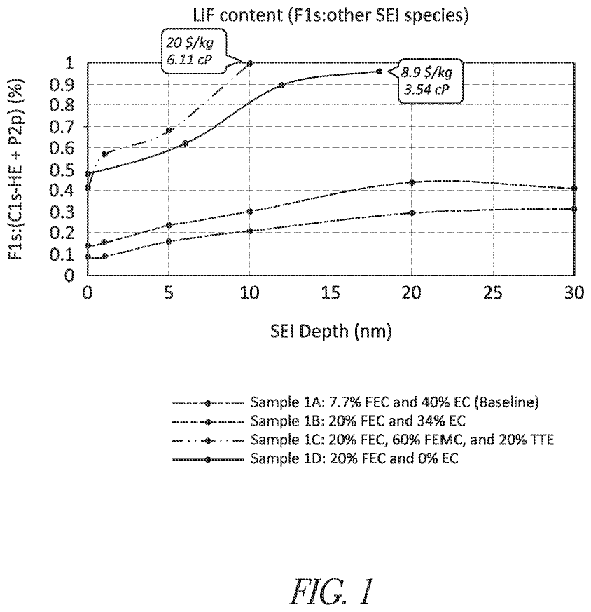

LiF and polymeric carbonate species were produced and characterized on the solid electrolyte interphase (SEI) of micron-silicon anodes, utilizing fluorinated electrolyte solvents such as fluoroethylene carbonate (FEC). FIG. 1 shows the results of an x-ray photoelectron spectroscopy (XPS) study which highlights the ratio of LiF content versus carbonate species in SEI's on micron-silicon anodes cycled in various electrolyte formulations. Sample 1A (also “Baseline” or “TB Baseline”) included an electrolyte comprising 39.7 wt. % EC and 7.7 wt. % FEC, and Sample 1B (also “fluorinated TB Baseline”) included an electrolyte comprising 34 wt. % EC and 20 wt. % FEC. The SEI's on the micron-silicon anode in the electrolytes of Sample 1A and Sample 1B are similar. Sample 1C included an electrolyte comprising 20 wt. % FEC, 60 wt. % methyl 2,2,2-trifluoroethyl carbonate (FEMC), and 20 wt. % 1,1,2,2-tetrafluoroethyl-2,2,3,3-tetrafluoropropylether (TTE). Sample 1D (also “TB-156”) included an electrolyte comprising 0 wt. % EC and 20 wt. % FEC, and shows a substantially higher LiF: carbonate ratio compared to the electrolytes containing EC.

This high LiF: carbonate ratio is advantageous, since LiF has a high bandgap (electron insulator) and is conductive to lithium ions, making it a valuable component in the SEI. In addition, polymeric carbonate species, such as poly-vinylenecarbonates (poly-VCs), can provide flexibility that is important to accommodate the expansion and contraction of materials like silicon. Both LiF and poly-VCs are formed by FEC reduction pathways.

### Example 2—Cycling Performance of Pouch Cells with Micron-Silicon Anodes

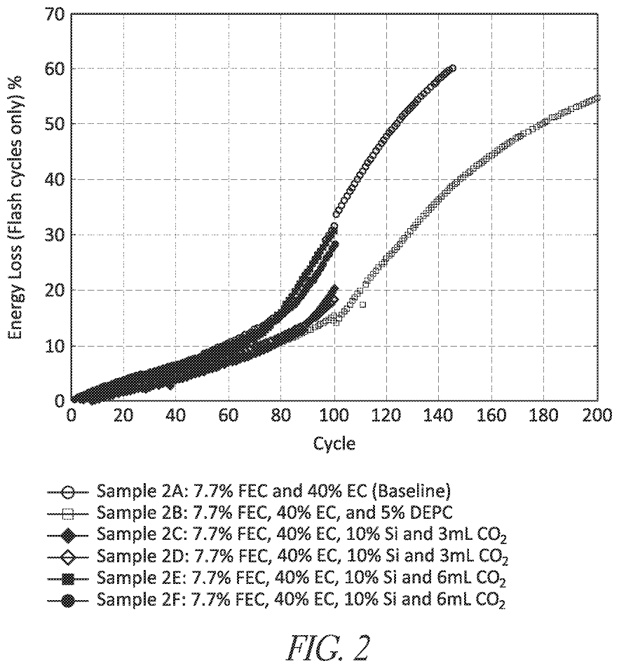

Cycling data comparing pouch cells with a micron-silicon anode and NMC811 cathode at 4.1-2.85V, C3: C2 cycling were also tested, and the results are depicted in FIG. 2. Various amounts of CO₂ were injected into cells and compared against baseline cycling performance. The CO₂ injection was achieved using a CO₂ filled syringe in a glovebox such that no ambient air was allowed into the cells. As shown in FIG. 2, 3 mL CO₂ content resulted in a 30-40% improvement in cycle life (to 30% energy loss) while diminishing the catastrophic failure of the cell (i.e., a lower slope in the energy loss curve at end-of-life), as depicted in Sample 2C and Sample 2D. 6 mL CO₂ content produced pouch cells that were expanded, possibly degrading the electrode stack's mechanical integrity, as depicted in Sample 2E and Sample 2F. In this case, Sample 2A (also “Baseline” or “TB Baseline”) including an electrolyte comprising 39.7 wt. % EC and 7.7 wt. % FEC was used to study the gas addition. The results shown in FIG. 2 demonstrate the concept that CO₂ saturation of the electrolyte greatly improves the SEI properties and cycle life with high energy density silicon anodes.

FIG. 2 also shows that injection of 3 mL CO₂ gas performed similarly to Sample 2B, which comprised 5 wt. % DEPC in the electrolyte formulation.

### Example 3—XPS Characterization of SEI Constituents Resulting from the Cycling of EC-Free Electrolytes with and without DEPC

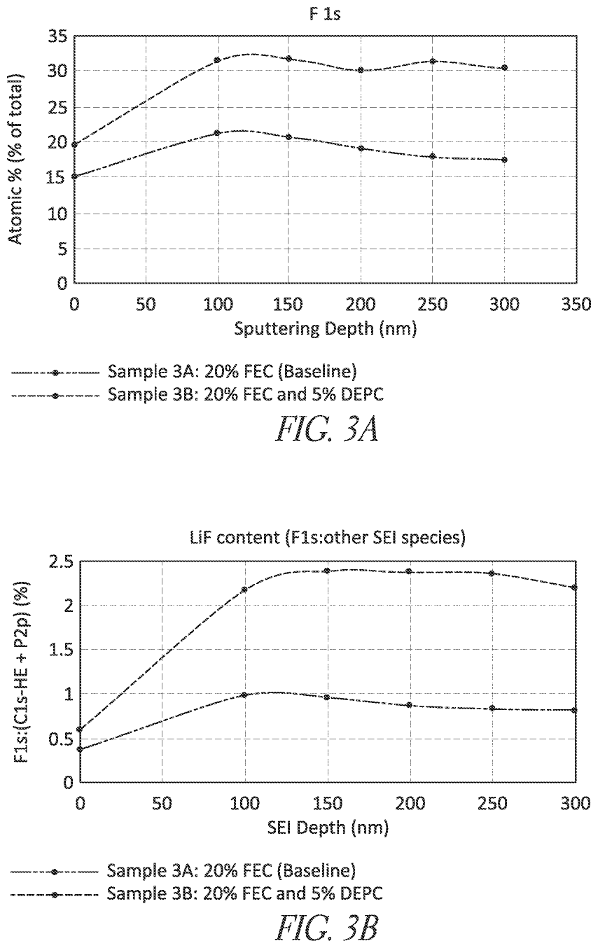

An XPS study comparing EC-free electrolyte with and without DEPC was also tested. The ratio of LiF is compared to other SEI species for an electrolyte without DEPC additive and with 5 wt. % DEPC additive. FIG. 3A shows the atomic percent of F 1s versus sputter depth. As shown in FIG. 3A, Sample 3B, which comprised an electrolyte with 5 wt. % DEPC provided a higher atomic percentage of F 1s, compared to Sample 3A, which comprised an electrolyte without DEPC. As shown in FIG. 3B, Sample 3A formed a SEI with a significantly higher ratio of LiF:carbonate species. This represents a further improvement from the SEI characterized in FIG. 1. Thus, by both removing EC and adding CO₂, a higher performance SEI was created. In addition, employing the EC-free, CO₂ saturated electrolyte resulted in a thinner SEI. After 90% more cycle life, the SEI formed by the EC-free, 20 wt. % FEC, CO₂ saturated electrolyte is approximately the same thickness as that of the baseline electrolyte at end-of-life (defined as 70% energy retention). The fact that the SEI takes more cycles to achieve the same thickness coincides with the lower lithium-ion inventory loss in the better electrolyte, since SEI formation/re-formation consumes lithium-ions and leads to early cell failure.

### Example 4—Capacity Retention Performance

Formation of a SEI with the maximum LiF: carbonate ratio led to drastically improved cycle life in lithium-ion cells. This was exhibited in pouch cells containing a micron-silicon anode and NMC811 cathode, cycled from 4.1-2.85V C3: C2 cycling (>90% depth-of-discharge).

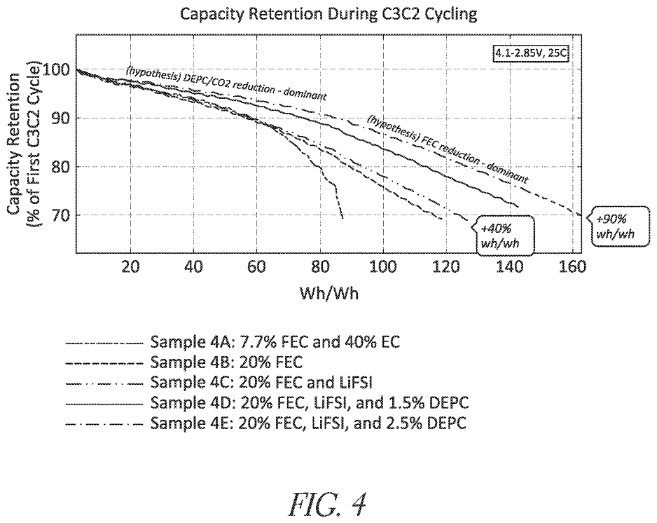

FIG. 4 highlights the cycle life improvements garnered by removing EC, increasing FEC to 20 wt. %, and then adding increasing amounts of DEPC. This is an advantageous high energy density cell design, incorporating micron-silicon anode technology. Specifically, Sample 4A, which included an electrolyte comprising >30 wt. % EC and 7.7 wt. % FEC, was compared to Sample 4B, which included an EC-free, 20 wt. % FEC electrolyte formulation. Sample 4C included an EC-free, 20 wt. % FEC electrolyte formulation with LiFSI. Various amounts of DEPC were added into the EC-free, 20 wt. % FEC formulation, as depicted in Sample 4D and Sample 4E.

As seen in FIG. 4, by removing EC and adding 20 wt. % FEC, a cycle life improvement of 40% was demonstrated, as depicted in Sample 4B and Sample 4C. By adding just 2.5 wt. % DEPC to the EC-free, high FEC electrolyte, the cycle life nearly doubled over the baseline, as depicted in Sample 4E. This cycling study shows the step-wise improvements brought by changes in the electrolyte formulation, resulting in a 90+% improvement in cycle life in this aggressive cycle test.

### Example 5—CO₂ Gas Generation

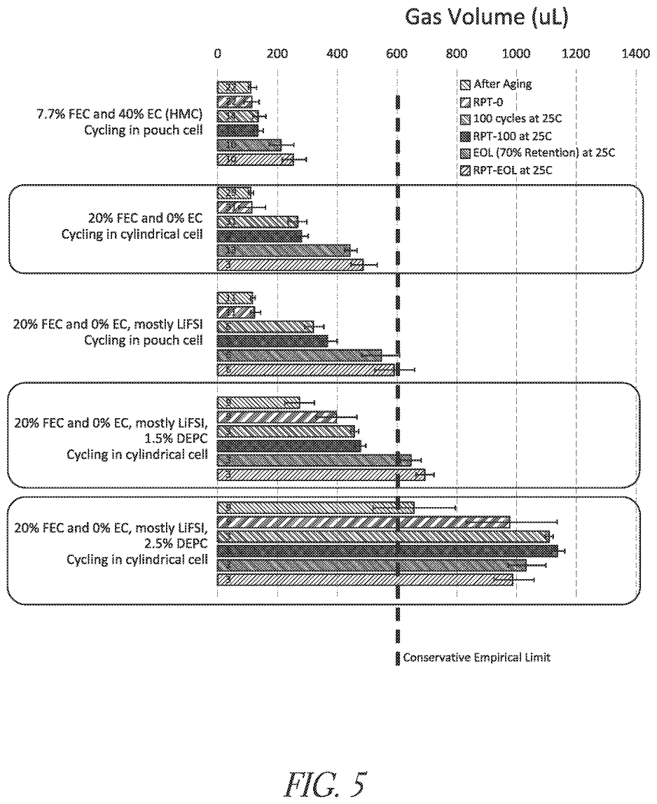

Gas volumes of CO₂ generated by various electrolytes were compared in pouch cells with a micron-silicon anode and NMC811 cathode during formation cycling and under 4.1-2.85V, C3: C2 cycling conditions. FIG. 5 shows the optimization of CO₂ gas volumes in EC-free, high FEC electrolytes with the DEPC additive. The CO₂ gas volume was measure after aging (“After Aging”), immediately following formation (also “initial reference performance test” or “RPT-0”), after 100 cycles at 25 ° C (“100 cycles at 25 ° C”), after a reference performance test consisting of 100 cycles at 25 ° C (also “RPT-100 at 25 ° C”), at the end-of-life (also “EOL” or 70% energy retention at 25 ° C), and after a reference performance test at the end-of-life (also “RPT-EOL at 25 ° C”). The CO₂ gas volume was measure in pouch cells comprising 7.7 wt. % FEC and 40 wt. % EC (HMC); in cylindrical cells comprising 20 wt. % FEC and 0 wt. % EC; in pouch cells comprising 20 wt. % FEC, 0 wt. % EC and LiFSI; in cylindrical cells comprising 20 wt. % FEC, 0 wt. % EC, LiFSI, and 1.5 wt. % DEPC; and in cylindrical cells comprising 20 wt. % FEC, 0 wt. % EC, LiFSI, and 2.5 wt. % DEPC. As shown in FIG. 5, it was determined that 1.5-2.5 wt. % DEPC is commercially viable and showed significant improvement in cycle life.

As demonstrated in FIG. 5, the cycle life of the micron-silicon anode doubled via incorporation of an EC-free, high FEC electrolyte with CO₂ saturation. The same electrolyte strategy has broad applicability to various lithium-ion and lithium-metal cell designs based on the SEI characteristics described herein. The same LiF: carbonate ratio in the SEI also improved cycle life for anodes ranging from graphite, to SiC materials, to lithium metal.

### Example 6—Pouch Cell Discharge Capacity

Electrolytes and additives were tested in pouch cell format with NMC-based cathodes and composite micron-silicon/graphite anodes. Pouch cells were filled with electrolyte and vacuum sealed inside a glovebox. Pouch bags were sized to allow for excess gas to expand into an unconstrained portion of the bag. Cells were not degassed after initial sealing. For cells that were injected with gaseous carbon dioxide, feed-through ports were incorporated in the pouch cell construction and injection of carbon dioxide occurred after the cell was filled with electrolyte and sealed. Pouch cell fixtures were used to apply constant stack pressure on the cell throughout cycling while allowing for gas to expand into the unconstrained portion of the pouch bag.

Electrochemical cycling tests were performed at 25 °C. All cells were cycled under asymmetric galvanostatic-potentiostatic (CC-CV) charge-discharge conditions with voltage cutoffs in the 4.2 and 2.85V range at charge-discharge rates between C/20 and C/2, depending on the experiment. All capacity measurements were normalized by the active material mass loading of the cathode.

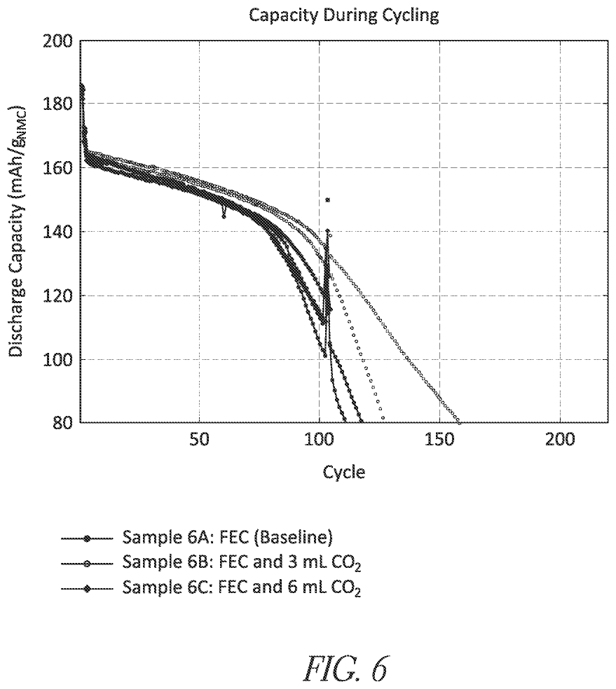

Cycling data showed improved lifetime performance with the direct injection of gaseous carbon dioxide into pouch cells via feed-through ports. FIG. 6 shows discharge capacity versus cycle number of cells with electrolyte systems injected with gaseous carbon dioxide. Carbon dioxide was introduced directly into cells by injecting gaseous carbon dioxide via a feed-through port on the cell. FIG. 6 shows that pouch cells inject with 3 mL and 6 mL of gaseous carbon dioxide, such as Sample 6B and Sample 6C, respectively, provided superior discharge capacity during cycling, compared to baseline electrolyte system which were not included with gaseous carbon dioxide, such as Sample 6A.

### Example 7—Discharge Capacity and Gas Production with Varying Amounts of FEC

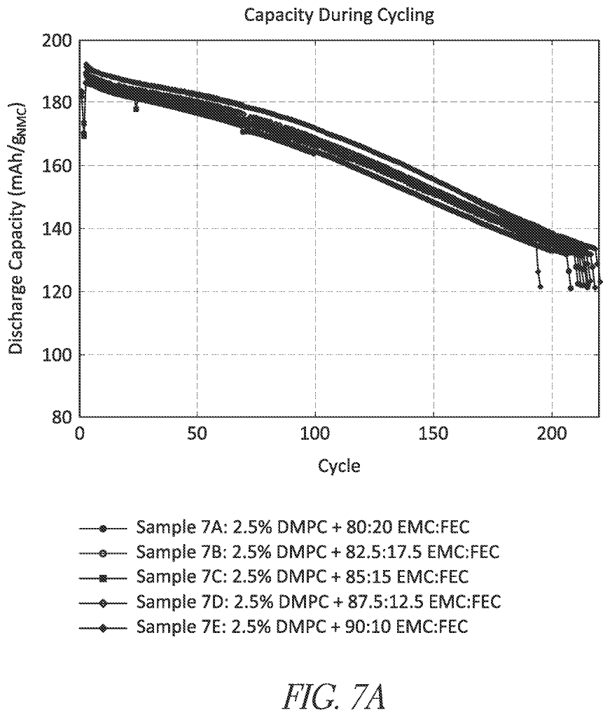

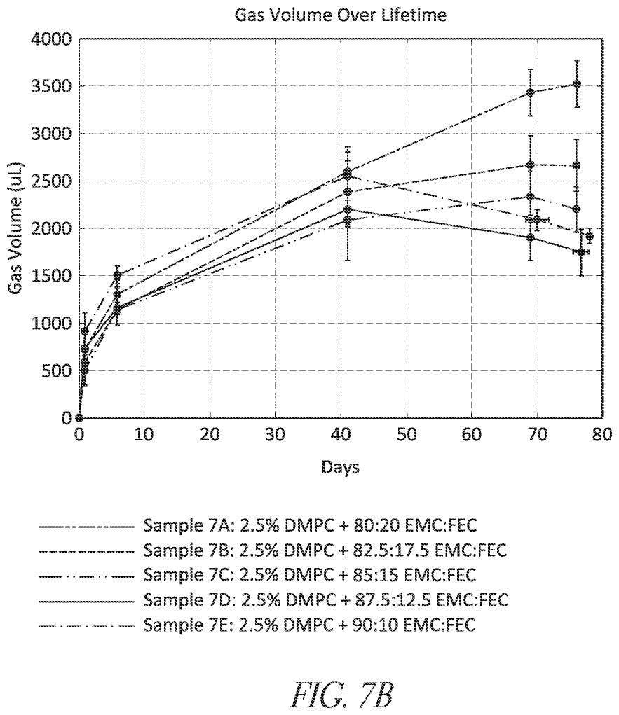

Electrolytes were tested with varying amounts of fluoroethylene carbonate (FEC). FIG. 7A is a plot showing discharge capacity versus cycle number of cells with electrolyte systems comprising varying amounts of solvent blends. FIG. 7A shows data for Sample 7A, which comprised 2.5 wt. % DMPC, 80 wt. % EMC, and 20 wt. % FEC; Sample 7B, which comprised 2.5 wt. % DMPC, 82.5 wt. % EMC, and 17.5 wt. % FEC; Sample 7C, which comprised 2.5 wt. % DMPC, 85 wt. % EMC, and 15 wt. % FEC; Sample 7D, which comprised 2.5 wt. % DMPC, 87.5 wt. % EMC, and 12.5 wt. % FEC; and Sample 7E, which comprised 2.5 wt. % DMPC, 90 wt. % EMC, and 10 wt. % FEC.

Surprisingly, the use of 10% FEC, such as Sample 7E, provided better results than the use of 20% FEC, such as Sample 7A.

In addition, pouch cells were measured periodically throughout cycle life for changes in volume. The measurements presented herein were obtained ex situ by removing the cell from the fixture and briefly submerging the cell in deionized water or oil. Buoyancy forces were determined via lab balance and volumetric changes were calculated based on changes in buoyancy, as compared to initial measurements prior to cycling.

Lower FEC content showed smaller gas volumes at end-of-life, compared to electrolytes with higher FEC content. Specifically, FIG. 7B shows the gas formation of the same electrolyte systems as those used in FIG. 7A. Again, the use of 10% FEC provided better results than the use of 20% FEC.

### Example 8—Discharge Capacity and Gas Production of Electrolytes Including DEPC

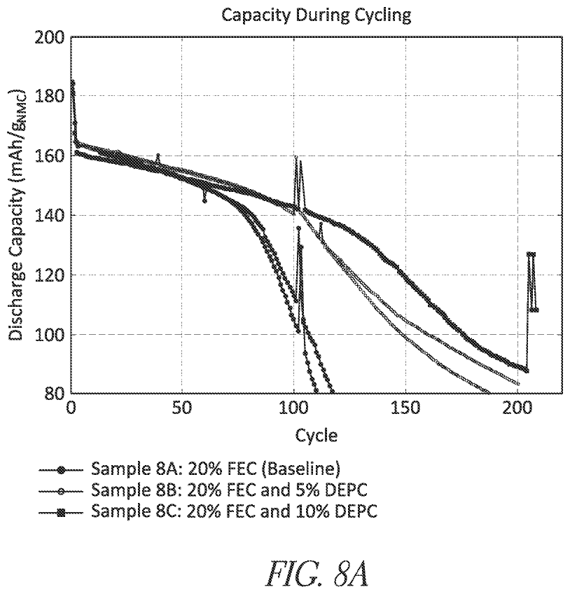

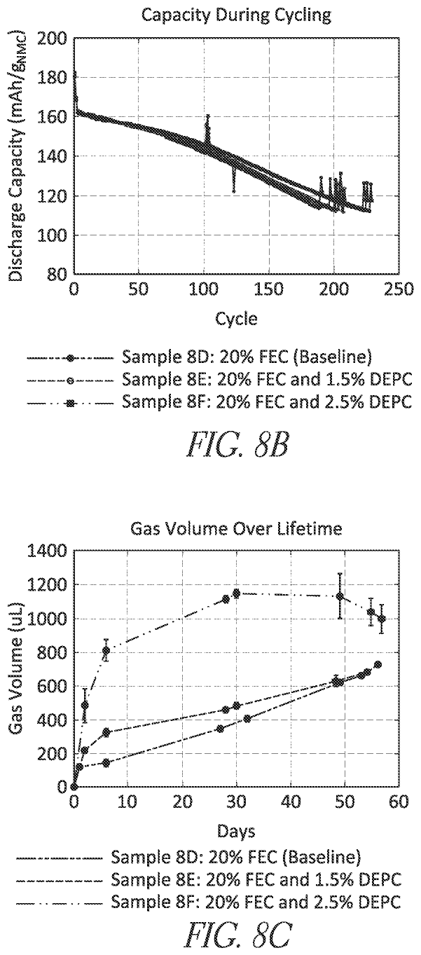

Cycling data showed improvement in lifetime performance with the addition of diethyl pyrocarbonate (DEPC), an electrolyte additive that produces carbon dioxide in situ. FIG. 8A shows data for Sample 8A, which comprised 20 wt. % FEC (also “Baseline”); Sample 8B, which comprised 20 wt. % FEC and 5 wt. % DEPC; and Sample 8C, which comprised 20 wt. % FEC and 10 wt. % DEPC. FIGS. 8B and 8C show data for Sample 8D, which comprised 20 wt. % FEC (also “Baseline”); Sample 8E, which comprised 20 wt. % FEC and 1.5 wt. % DEPC; and Sample 8F, which comprised 20 wt. % FEC and 2.5 wt. % DEPC. FIGS. 8A and 8B show discharge capacity versus cycle number of cells with electrolyte systems comprising diethyl pyrocarbonate (DEPC) relative to a baseline electrolyte system. As shown in FIGS. 8A and 8B, the use of DEPC provided improved results relative to baseline electrolyte systems without DEPC.

In addition, FIG. 8C shows the gas formation of electrolyte systems comprising diethyl pyrocarbonate (DEPC), relative to a baseline electrolyte system without DEPC. As shown in FIG. 8C, the use of 1.5% DEPC, such as Sample 8E, provided similar results to baseline electrolyte systems without DEPC, such as Sample 8D.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount, depending on the desired function or desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. An energy storage device comprising:
a cathode;
an anode; and
an electrolyte comprising a lithium salt, a carbon dioxide source and a fluorinated solvent.

2. The energy storage device of claim 1, wherein a concentration of the carbon dioxide source in the electrolyte is in a range from 0.1 to 10% by weight.

3. The energy storage device of claim 1, wherein the carbon dioxide source is selected from the group consisting of gaseous carbon dioxide, dry ice, diethyl pyrocarbonate (DEPC), dimethyl pyrocarbonate (DMPC), diallyl pyrocarbonate (DAPC), bis(tert-butyl) pyrocarbonate (O-Boc2), and combinations thereof.

4. The energy storage device of claim 3, wherein the carbon dioxide source is diethyl pyrocarbonate.

5. The energy storage device of claim 4, wherein the concentration of the diethyl pyrocarbonate in the electrolyte is in a range from 1 to 6% by weight.

6. The energy storage device of claim 5, wherein the concentration of the diethyl pyrocarbonate in the electrolyte is in a range from 1.5 to 2.5% by weight.

7. The energy storage device of claim 1, wherein a concentration of the fluorinated solvent in the electrolyte is in a range from 5 to 80% by weight.

8. The energy storage device of claim 7, wherein the concentration of the fluorinated solvent in the electrolyte is in a range from 5 to 20% by weight.

9. The energy storage device of claim 1, wherein the fluorinated solvent is selected from the group consisting of fluoroethylene carbonate (FEC), difluoroethylene carbonate (diFEC), methyl 2,2,2-trifluoroethyl carbonate (FEMC), bis(2,2,2-trifluoroethyl) carbonate (TFEC), trifluoropropylene carbonate (TFPC), 2,2,3,3-tetrafluoro-1,4-dimethoxybutane (fDMB), bis(2,2,2-trifluoroethyl) ether (BTFE), 1,1,2,2-tetrafluoroethyl-2,2,3,3-tetrafluoropropylether (TTE), and combinations thereof.

10. The energy storage device of claim 9, wherein the fluorinated solvent is fluoroethylene carbonate.

11. The energy storage device of claim 1, wherein the anode comprises silicon particles.

12. The energy storage device of claim 11, wherein the d₅₀ of the silicon particles is 1-5 microns.

13. The energy storage device of claim 12, wherein the d₅₀ of the silicon particles is 2-3 microns.

14. The energy storage device of claim 1, wherein the electrolyte is substantially free of ethylene carbonate and dimethylcarbonate.

15. The energy storage device of claim 1, wherein the anode comprises a graphite insertion material and a silicon alloying/dealloying material.

16. The energy storage device of claim 1, wherein the cathode comprises an active material selected from the group consisting of lithium nickel manganese cobalt oxide (NMC), lithium manganese oxide (LMO), lithium nickel dioxide (LNO), lithium iron phosphate (LFP), and lithium nickel cobalt aluminium oxide (NCA).

17. The energy storage device of claim 1, wherein the lithium salt is selected from the group consisting of lithium hexafluorophosphate, lithium bis(fluorosulfonyl)imide, and combinations thereof.

18. The energy storage device of claim 1, wherein the energy storage device is configured to have at least 70% retention of initial capacity after 100 cycles between 4.1 V and 2.85 V at a charging rate of C3: C2.

19. The energy storage device of claim 1, wherein the energy storage device is configured to have at least 70% retention of initial capacity after 140 cycles between 4.1 V and 2.85 V at a charging rate of C3: C2.

20. The energy storage device of claim 1, wherein the energy storage device is configured to have at least 70% retention of initial capacity after 225 cycles between 4.2 V and 2.85 V at a charging rate of C₄: C3.

21. The energy storage device of claim 1, wherein the energy storage device is a battery.

22. An electric vehicle with a rechargeable battery comprising:
a drive motor;
gear box;
electronics; and
the energy storage device of claim 1.

23. A method of preparing an electrolyte, comprising combining a carbon dioxide source, a fluorinated solvent and a lithium salt to form an electrolyte.

24. The method of claim 23, further comprising aging the electrolyte.

25. The method of claim 23, further comprising filling the electrolyte into an energy storage device.

26. The method of claim 23, wherein the electrolyte is positioned within an energy storage device.
